(19) United States
(12) Patent Application Publication
(10) Pub. No.: US 2011/0292264 A1
(43) Pub. Date: Dec. 1, 2011

(54) SOLID-STATE IMAGING DEVICE AND IMAGING APPARATUS INCLUDING THE SAME

(75) Inventor: Hiroshi KUBO, Osaka (JP)

(73) Assignee: PANASONIC CORPORATION, Osaka (JP)

(21) Appl. No.: 13/205,996

(22) Filed: Aug. 9, 2011

Related U.S. Application Data
(63) Continuation of application No. PCT/JP2009/006554, filed on Dec. 2, 2009.

(30) Foreign Application Priority Data
Feb. 13, 2009 (JP) 2009-031505

(51) Int. Cl. H04N 5/335

(52) U.S. Cl. 348/301; 348/294; 348/E05.091

(57) ABSTRACT

To provide a solid-state imaging device and an imaging apparatus including the solid-state imaging device that are capable of reducing occurrence of vertical stripes on an image while suppressing a black level shift thereon. A clipping circuit operation change-over switch enables a clip transistor when a column comparison unit determines that the voltage of a pixel signal is lower than a reference voltage for determination, and disables the clip transistor when the column comparison unit determines that the voltage of the pixel signal is higher than or equal to the reference voltage for determination.

### CROSS REFERENCE TO RELATED APPLICATION

This is a continuation application of PCT application No. PCT/JP2009/006554 filed on Dec. 2, 2009, designating the United States of America.

### BACKGROUND OF THE INVENTION

(1) Field of the Invention

The present invention relates to a solid-state imaging device that includes a plurality of pixels arranged in rows and columns, and column signal lines respectively provided for the columns of the pixels, for transmitting pixel signals from the pixels in the corresponding column, and to an imaging apparatus including the solid-state imaging device.

(2) Description of the Related Art

A solid-state imaging device has been proposed which is provided with a clip transistor for limiting the voltage of the column signal line corresponding to each column of the pixel array in order to suppress a black level shift in an almost black image where only a portion of the pixel array receives high luminance incident light, but the rest of the portion receives no incident light (for example, see Japanese Unexamined Patent Application No, 2001-230974, hereinafter referred to as Patent Reference 1).

FIG. 10 shows a pixel source follower circuit for reading data from the pixel array in a conventional solid-state imaging element described in Patent Reference 1.

As seen from FIG. 10, a clip transistor (clip Tr) M71 and a clip switch (SW) M81, a clip Tr M72 and a clip SW M82, and a clip Tr M73 and a clip SW M83 are respectively connected to a column signal line V1, a column signal line V2, and a column signal line V3 that are disposed for each column of the pixel source follower.

In the circuit of FIG. 10, each of the clip Tr M71, the clip Tr M72 and the clip Tr M73, and the corresponding pixel source follower operates as an independent differential pair per column by turning on the clip SW M81, M82, and M83 simultaneously when pixel data is read by the pixel source follower. For example, in the column signal line V1, the pixel source follower and the clip Tr M71 operate as a differential pair.

With this configuration, even in the case where a phenomenon (hereinafter referred to as a phenomenon PH1) occurs in which an amount of electrons causing the input gate voltage of a pixel source follower to be reduced to a level lower than the gate voltage (=clipping voltage) of the clip Tr M71, M72, and M73 is inputted to the input gate terminal of the pixel source follower, the output voltage of the pixel source follower is maintained at the voltage specified by the clipping voltage. In this situation, the setting of the clipping voltage is such that the voltages of the column signal lines V1, V2, and V3 allow load transistors M51, M52, and M53 of the pixel source follower to operate in their saturation regions.

Thereby, even in the case where considerably large quantity of signal charges is read, the load transistors M51, M52, and M53 can be prevented from being turned off. As a result, even in the case where the phenomenon PH1 occurs in a portion of the pixel source followers, the amount of the current that flows through a GND (ground) line 204 is maintained at a substantially constant level, and the output voltages of those pixel source followers that have not experienced the phenomenon PH1 can be also maintained at a substantially constant level. In other words, a black level shift is suppressed in an almost black image where only a portion of the pixel array receives high luminance incident light and thus is white, but the rest of the portion receives no incident light.

### SUMMARY OF THE INVENTION

In Patent Reference 1, a method of suppressing a black level shift has been disclosed, in which whenever pixel data is read by the pixel source follower, the clip SW M81 to M83 are turned on to allow clip Tr M71 to M73 to operate.

However, in the method described in Patent Reference 1, the operations of the pixel source followers and the clip SW M81 to M83 are synchronized, thus the operation of the clip Tr M71 to M73 in a weak inversion region affects the output voltage of the pixel source follower. In other words, in the case where a phenomenon (hereinafter referred to as a phenomenon PH2) occurs in which an amount of electrons causing the input gate voltage of a pixel source follower to be increased to a level higher than the gate voltage of the clip Tr M71, M72, and M73 is inputted to the input gate terminal of the pixel source follower, the clip Tr M71, M72, and M73 operate. That is to say, even in the case of low luminance incident light, the clip Tr M71, M72, and M73 operate in the weak inversion region so that a weak current flows through the clip Tr M71, M72, and M73.

Consequently, the output voltage of the pixel source follower is higher by ΔV than that of a pixel source follower circuit to which no clip Tr is connected. Also, due to a variation in the clip Tr M71, M72, and M73, the output voltages of the pixel source followers are different according to their columns even in a state where each pixel receives uniform incident light whose luminosity does not cause the phenomenon PH1.

Therefore, the solid-state imaging device shown in Patent Reference 1 has a problem in that even in the case where the pixels receive uniform incident light whose luminosity does not cause the phenomenon PH1, the output voltages of the pixel source followers are different according to their columns. Thus, the solid-state imaging device has a problem in that vertical stripes appear on an image.

In view of the above-described problem, an object of the present invention is to provide a solid-state imaging device and an imaging apparatus that can reduce occurrence of vertical stripes while suppressing a black level shift.

In order to achieve the above-mentioned object, the solid-state imaging device according to one aspect of the present invention has a plurality of pixels arranged in rows and columns, and a column signal line which is provided for each of the columns of the pixels and transmits a pixel signal from the pixels in the column, the solid-state imaging device including: a comparison unit provided for each of the column signal lines and configured to compare a voltage of the pixel signal with a reference voltage, and to determine whether or not the voltage of the pixel signal is lower than the reference voltage; a limiting unit provided for each of the column signal lines and configured to limit the voltage of the pixel signal to a clipping voltage; and a switching unit provided for each of the column signal lines and configured to switch between enabled and disabled states of the limiting unit, wherein the switching unit is configured to enable operation of the limiting unit when the comparison unit determines that the voltage of the pixel signal is lower than the reference voltage, and to disable operation of the limiting unit when the comparison unit determines that the voltage of the pixel signal is higher than or equal to the reference voltage.

Thereby, the state of the limiting unit can be switched between enabled and disabled states based on a comparison result made by the comparison unit, thus when the voltage of the pixel signal is higher than or equal to the reference voltage, the operation of the limiting unit can be prevented and occurrence of vertical stripes on the image can be prevented. In addition, when the voltage of the pixel signal is less than the reference voltage, the limiting unit is enabled to limit the voltage of the pixel signal at the clipping voltage, thus even in the case where only a portion of the pixels receives high luminance incident light, but the rest of the portion receives no incident light, a black level shift can be suppressed.

Also, the switching unit may include a transistor inserted in a wiring which connects between the limiting unit and the column signal line, and the transistor may be connected at its gate to an output line of the comparison unit and configured to enable an electrical connection between the limiting unit and the column signal line when the comparison unit determines that the voltage of the pixel signal is lower than the reference voltage, and to disable an electrical connection between the limiting unit and the column signal line when the comparison unit determines that the voltage of the pixel signal is higher than or equal to the reference voltage.

Thereby, the switching unit can be easily formed with a transistor. Also, the switching unit switches between its on state and off state according to a comparison result made by the comparison unit, thus the transistor does not operate in the weak inversion region, and occurrence of vertical stripes on an image can be prevented.

Also, the solid-state imaging device may further includes a control unit configured to notify the comparison unit of the reference voltage, and to notify the limiting unit of the clipping voltage.

Thereby, a pixel signal can be limited to an arbitrary voltage or higher. Consequently, setting the reference voltage and the clipping voltage according to the current flowing through each column signal line can prevent deterioration of the quality of an image due to a variation in the currents of the column signal lines. Specifically, when the current flowing through the column signal line is large, the reference voltage and the clipping voltage are each set at a high level, while when the current is small, the reference voltage and the clipping voltage are each set at a low level.

Also, the solid-state imaging device may further include a variable gain amplifying unit which is provided for each of the column signal lines, and is configured to amplify the pixel signal, wherein the control unit further notifies the amplifying unit of a gain thereof so that the amplifying unit amplifies the pixel signal with the gain notified from the control unit.

Thereby, the gain of the amplifying unit can be adjusted according to the voltage of a pixel signal amplified by the amplifying unit. For example, by optimizing the gain according to the voltage at a timing immediately before the pixel signal is amplified by the amplifying unit, time-varying pixel signal can be always amplified with the optimized gain. Consequently, the gain of the amplifying unit can be automatically adjusted for pixel signals in various magnitudes, and the magnitude of the amplified pixel signals can be set independently of the magnitudes of the pixel signals, thus can be optimized to the subsequent processing by the amplifying unit.

Also, the solid-state imaging device may further include an A/D converter which is provided for each of the column signal lines, and is configured to digitally convert the pixel signal amplified by the amplifying unit so as to output a digital value, wherein the control unit further determines the gain of the amplifying unit so that the amplitude of the pixel signal amplified by the amplifying unit is suited to an optimized input range of the A/D converter, and determines the reference voltage and the clipping voltage according to the gain of the amplifying unit, and then notifies the comparison unit of the reference voltage and notifies the limiting unit of the clipping voltage.

Thereby, even after the conversion by the A/D converter, the S/N of the pixel signal is favorably maintained. For example, by optimizing the gain of the amplifying unit for the subsequent digital conversion based on an output result of the preceding digital conversion, the gain for time-varying pixel signal can be always optimized and the S/N of the pixel signal after the A/D conversion is favorably maintained.

Furthermore, setting the reference voltage and the clipping voltage according to the gain of the amplifying unit increases the quality of the image. Specifically, when the gain is small, i.e., the amount of received light is large, the variation in the currents of the pixel source followers of the solid-state imaging device has a small affect on the image quality. Thus, the reference voltage and the clipping voltage are each set to a low level. On the other hand, when the gain is large, i.e., the amount of received light is small, the variation in the currents of the pixel source followers has a huge affect on the image quality, thus the reference voltage and the clipping voltage are each set to a high level so that the variation in the currents of the pixel source followers are suppressed. Consequently, the affect of noise can be suppressed at the time of low luminance of light, thus the image quality improves.

Also, the control unit may further determine a gain of the amplifying unit so that the amplitude of the pixel signal amplified by the amplifying unit is suited to an optimized input range of an A/D converter disposed externally of the solid-state imaging device, and may determine the reference voltage and the clipping voltage according to the gain of the amplifying unit, and then may notify the comparison unit of the reference voltage and may notify the limiting unit of the clipping voltage.

Thereby, even in the case where the solid-state imaging device outputs an analog pixel signal, the S/N of the pixel signal is favorably maintained. Thus the image quality improves.

Also, the imaging apparatus according to one aspect of the present invention includes the above-described solid-state imaging device.

### EFFECTS OF THE INVENTION

The solid-state imaging device and the imaging apparatus according to the present invention can reduce occurrence of vertical stripes on an image while suppressing a black level shift.

### FURTHER INFORMATION ABOUT TECHNICAL BACKGROUND TO THIS APPLICATION

The disclosure of Japanese Patent Application No. 2009-031505 filed on Feb. 13, 2009 including specification, drawings and claims is incorporated herein by reference in its entirety.

The disclosure of PCT application No. PCT/JP2009/006554 filed on Dec. 2, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A is a block diagram showing the configuration of a solid-state imaging device for outputting an analog signal, according to a first embodiment of the present invention;

FIG. 1B is a block diagram showing the configuration of the solid-state imaging device for outputting a digital signal, according to the first embodiment of the present invention;

FIG. 2 is a circuit diagram showing the configuration of the solid-state imaging device according to the first embodiment of the present invention;

FIG. 3 is a timing chart showing the operation in the case of small amount of received light of the solid-state imaging device according to the first embodiment of the present invention;

FIG. 4 is a timing chart showing the operation in the case of large amount of received light of the solid-state imaging device according to the first embodiment of the present invention;

FIG. 5 is a circuit diagram showing the configuration of a solid-state imaging device according to a second embodiment of the present invention;

FIG. 6 is a timing chart showing the operation in the case of small amount of received light of the solid-state imaging device according to the second embodiment of the present invention;

FIG. 7 is a timing chart showing the operation in the case of large amount of received light of the solid-state imaging device according to the second embodiment of the present invention;

FIG. 8A is a device configuration diagram showing an exemplary imaging apparatus according to a third embodiment of the present invention;

FIG. 8B is a device configuration diagram showing another exemplary imaging apparatus according to the third embodiment of the present invention;

FIG. 9A is an external appearance showing an exemplary imaging apparatus according to the third embodiment of the present invention;

FIG. 9B is an external appearance showing another exemplary imaging apparatus according to the third embodiment of the present invention; and

FIG. 10 is a circuit diagram showing the configuration of a conventional solid-state imaging device described in Patent Reference 1.

### DESCRIPTION OF THE PREFERRED EMBODIMENTS

### First Embodiment

The solid-state imaging device according to one aspect of the present invention has a plurality of pixels arranged in rows and columns, and a column signal line which is provided for each of the columns of the pixels and transmits a pixel signal from the pixels in the column, the solid-state imaging device including: a comparison unit provided for each of the column signal lines and configured to compare a voltage of the pixel signal with a reference voltage, and to determine whether or not the voltage of the pixel signal is lower than the reference voltage; a limiting unit provided for each of the column signal lines and configured to limit the voltage of the pixel signal to a clipping voltage; and a switching unit provided for each of the column signal lines and configured to switch between enabled and disabled states of the limiting unit, wherein the switching unit is configured to enable operation of the limiting unit when the comparison unit determines that the voltage of the pixel signal is lower than the reference voltage, and to disable operation of the limiting unit when the comparison unit determines that the voltage of the pixel signal is higher than or equal to the reference voltage.

Thereby, the state of the limiting unit can be switched between enabled and disabled states based on a comparison result made by the comparison unit, thus when the voltage of the pixel signal is higher than or equal to the reference voltage, the operation of the limiting unit can be prevented and occurrence of vertical stripes on the image can be prevented. In addition, when the voltage of the pixel signal is less than the reference voltage, the limiting unit to is enabled to limit the voltage of the pixel signal at the clipping voltage, thus even in the case where only a portion of the pixels receives high luminance incident light, but the rest of the portion receives no incident light, a black level shift can be suppressed.

Hereinafter, the solid-state imaging device according to a first embodiment of the present invention is described with reference to the drawings.

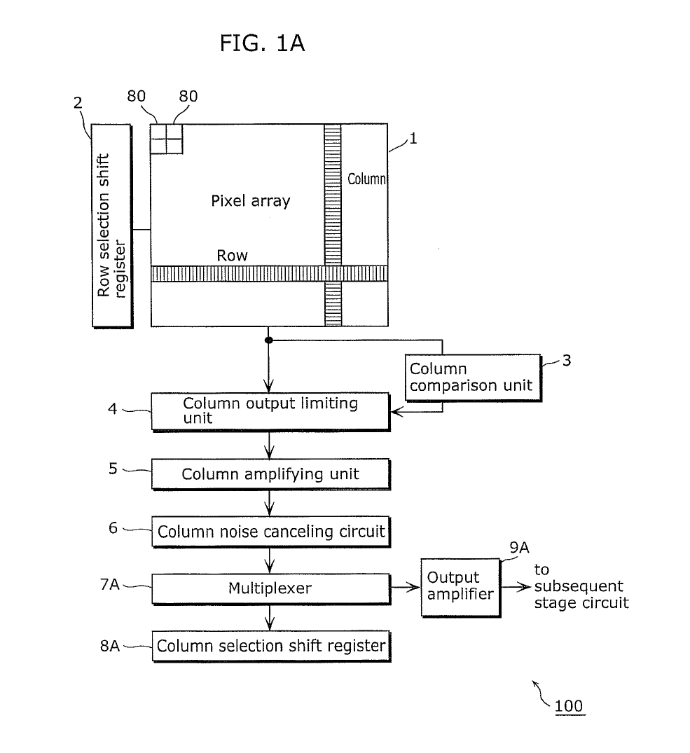

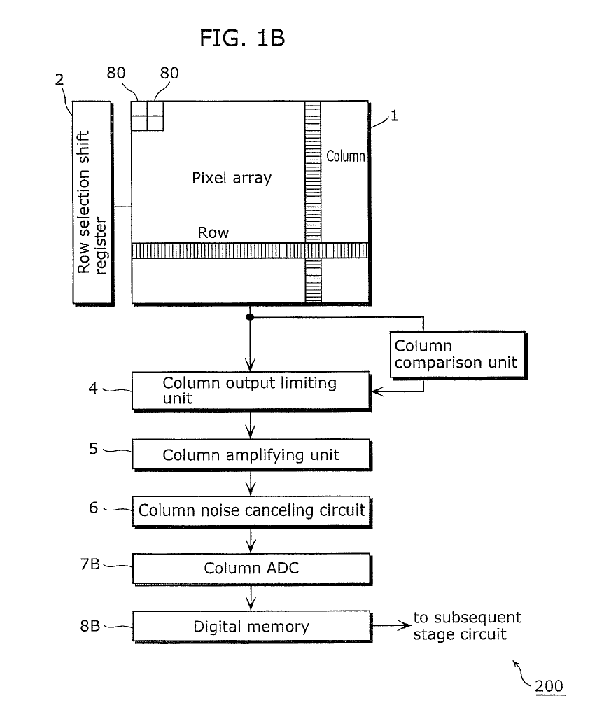

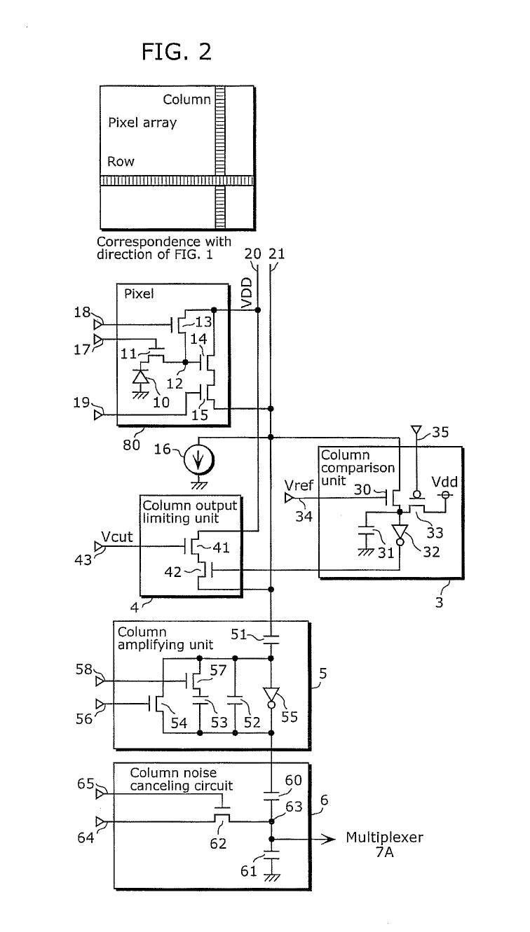

FIG. 1A is a block diagram showing the configuration of a solid-state imaging device for outputting an analog signal, according to the first embodiment of the present invention. FIG. 1B is a block diagram showing the configuration of a solid-state imaging device for outputting a digital signal, according to the first embodiment of the present invention. Specifically, a solid-state imaging device 100 shown in FIG. 1A outputs a pixel signal from a pixel as an analog signal, and a solid-state imaging device 200 shown in FIG. 1B includes a column ADC (Analog Digital Converter) 7B, thus converts a pixel signal from a pixel to a digital signal and outputs it.

The solid-state imaging device 100 shown in FIG. 1A includes a pixel array 1, a row selection shift register 2, a column comparison unit 3, a column output limiting unit 4, a column amplifying unit 5, a column noise canceling circuit 6, a multiplexer 7A, a column selection shift register 8A, and an output amplifier 9A. Compared with the solid-state imaging device 100, the solid-state imaging device 200 shown in FIG. 1B does not include the multiplexer 7A, the column selection shift register 8A, and the output amplifier 9A, but includes the column ADC 7B and a digital memory 8B. The following description is for FIG. 1A.

The pixel array 1, in which pixels 80 are arranged in two dimensional form, is reset, stored with charge, and read row-by-row by the row selection shift register 2. The pixel signal read row-by-row from the pixel 80 is compared with a reference voltage for determination predefined by the column comparison unit 3, and it is determined whether or not the voltage of the pixel signal is lower than the reference voltage for determination.

The column output limiting unit 4 has the functions of the column limiting unit and the column switching unit, that is to limit the voltage of the pixel signal read line according to a comparison result made by the column comparison unit 3. Specifically, when the column comparison unit 3 determines that the voltage of the pixel signal is lower than the reference voltage for determination, the column output limiting unit 4 limits the voltage of the pixel signal read line. On the other hand, when the column comparison unit 3 determines that the voltage of the pixel signal is higher than or equal to reference voltage for determination, the column output limiting unit 4 limits no voltage of the pixel signal read line. In other words, the voltage of the pixel signal is as the voltage read from the pixel 80.

Each pixel signal is processed by the column output limiting unit 4, then is amplified by the column amplifying unit 5. The offset variation in the pixel signals amplified by the column amplifying unit 5 is canceled by the column noise canceling circuit 6, and is held thereby. The pixel signal for one row held by the column noise canceling circuit 6 is selected by the column selection shift register 8A, and is sequentially outputted via the multiplexer 7A, and the output amplifier 9A.

In the solid-state imaging device 200 shown in FIG. 1B, the pixel signal for one row held by the column noise canceling circuit 6 is converted to a digital signal by the column ADC 7B provided for each column, and the digital signal is held by the digital memory 8B. The pixel signal for one row held by the digital memory 8B is sequentially outputted to the subsequent stage circuits.

Next, FIG. 2 is a circuit diagram showing the configuration of the solid-state imaging device according to the first embodiment of the present invention. FIG. 2 is a detailed diagram of the device shown in FIG. 1A, but the column amplifying unit 5 and the column noise canceling circuit 6 in FIG. 1B may have the same configuration as in FIG. 2. Also, FIG. 2 shows the column comparison unit 3, the column output limiting unit 4, the column amplifying unit 5, and the column noise canceling circuit 6 for one pixel 80.

The pixel 80 has a photodiode (PD) 10 for generating electric charge by photoelectric conversion, a floating diffusion (FD) 12 for converting the electric charge generated by the PD 10 to a voltage, and a read transistor 14 for reading a signal according to the potential of the FD 12. Also, a transfer transistor 11 whose gate terminal is connected to an electric charge transfer signal line 17 is connected between the PD 10 and the FD 12, the transfer transistor 11 being controlled by an electric charge transfer signal. Also, the FD 12 is connected to a pixel drive power supply wiring 20 via a reset transistor 13 whose gate terminal is connected to a pixel reset signal line 18, the transistor 13 being controlled by a pixel reset signal. Also, a selection transistor 15 is, via the gate terminal thereof, connected to a pixel selection signal line 19 and is controlled by a pixel selection signal. Also, a read transistor 14 is, via the drain terminal thereof, connected to a pixel drive power supply wiring 20, and the source terminal of the read transistor 14 is connected to a pixel signal read line 21 via the selection transistor 15. Also, a current source 16 is connected to the pixel signal read line 21. The current source 16 serves as a source follower amplifier (pixel source follower) along with the read transistor 14. Also, the power supply voltage VDD is supplied to the pixel 80 and the column output limiting unit 4 via the pixel drive power supply wiring 20.

The column comparison unit 3 compares the voltage of the pixel signal outputted from the pixel 80 to the pixel signal read line 21 with the reference voltage for determination, and determines whether or not the voltage of the pixel signal is lower than the reference voltage for determination, then outputs a result made by the determination to the column output limiting unit 4. Specifically, the column comparison unit 3 includes an output voltage determination transistor 30, an output determination capacitor 31, a determination inversion unit 32 and an output determination unit reset transistor 33.

The output voltage determination transistor 30 is connected to the pixel signal read line 21 at one end, and to the input of the determination inversion unit 32 at the other end. Also, a reference voltage for determination wiring 34 is connected to the gate terminal of the output voltage determination transistor 30, to which the reference voltage for determination Vref is applied. Thereby, the output voltage determination transistor 30 has a function of comparing the reference voltage for determination Vref with the voltage of the pixel signal. Specifically, the output voltage determination transistor 30 is turned off when the voltage of the pixel signal read line 21 is higher than or equal to (Vref−Vthjdg), where Vthjdg is the threshold voltage of the output voltage determination transistor 30. On the other hand, the output voltage determination transistor 30 is turned on when the voltage of the pixel signal read line 21 is lower than (Vref−Vthjdg).

The output determination capacitor 31 is connected between the output line of the output voltage determination transistor 30 and the grand potential, and holds a comparison result made by the output voltage determination transistor 30.

The determination inversion unit 32 inverts the voltage level of the input terminal and outputs the inverted voltage level.

Specifically, the determination inversion unit 32 outputs Low level (L level) when the voltage held by the output determination capacitor 31 is High level (H level), while the determination inversion unit 32 outputs a H level when the voltage held by the output determination capacitor 31 is L level.

The output determination unit reset transistor 33 is inserted between the output line of the output voltage determination transistor 30 and the wiring to which the power supply voltage (Vdd) is applied, and the gate terminal of the output determination unit reset transistor 33 is connected to an output determination unit reset signal line 35, thus the voltage of the output determination capacitor 31 is reset after the output determination unit reset transistor 33 is turned on or off according to an output determination unit reset signal. Specifically, when the output determination unit reset signal is L level, the output determination unit reset transistor 33 is turned on, and the voltage held by the output determination capacitor 31 is reset to Vdd.

The output voltage determination transistor 30 is allowed to operate after the output determination capacitor 31 holds the voltage Vdd, thereby, when the voltage of the pixel signal is higher than or equal to (Vref−Vthjdg), the output determination capacitor 31 holds the voltage Vdd (H level), while when the voltage of the pixel signal is lower than the reference voltage for determination Vref, the output determination capacitor 31 holds L level.

In this manner, when the voltage of the pixel signal read line 21 is higher than or equal to (Vref−Vthjdg), the column comparison unit 3 outputs L level, while when the voltage of the pixel signal read line 21 is lower than (Vref−Vthjdg), the column comparison unit 3 outputs H level.

Next, the column output limiting unit 4 is described.

The column output limiting unit 4 limits the voltage of the pixel signal read line 21 according to a comparison result made by the column comparison unit 3, and specifically, includes a clip transistor 41 and a clipping circuit operation change-over switch 42.

The clip transistor 41 is connected to the pixel drive power supply wiring 20 at one end, and to the clipping circuit operation change-over switch 42 at the other end. A clip reference voltage wiring 43 is connected to the gate terminal of the clip transistor 41, to which a clipping voltage Vcut is applied. The clip transistor 41 limits the voltage of the pixel signal read line 21 to the clip reference voltage Vcut by the clipping circuit operation change-over switch 42. That is to say, the clip transistor 41 serves as a limiting unit.

The clipping circuit operation change-over switch 42 is connected to the clip transistor 41 at one end, and to the pixel signal read line 21 at the other. The gate terminal of the clipping circuit operation change-over switch 42 is connected to the output line of the column comparison unit 3. The clipping circuit operation change-over switch 42 switches between limiting and non-limiting of the voltage of the pixel signal read line 21 according to the output of the column comparison unit 3. Specifically, the clipping circuit operation change-over switch 42 is turned on when H level is inputted from the column comparison unit 3, and the voltage of the pixel signal read line 21 becomes (Vcut−Vthcut) where Vthcut is the threshold voltage of the clip transistor 41. On the other hand, the clipping circuit operation change-over switch 42 is turned off when L level is inputted from the column comparison unit 3, thus the clip transistor 41 is electrically disconnected to the pixel signal read line 21 and the voltage of the pixel signal read line 21 remains the same as before. That is to say, the clipping circuit operation change-over switch 42 serves as a switching unit that switches between enabled and disabled states of the limiting unit.

In this manner, the column output limiting unit 4 does not limit the voltage of the pixel signal read line 21 when the voltage thereof is determined to be higher than or equal to (Vref−Vthjdg) by the column comparison unit 3. On the other hand, the column output limiting unit 4 limits the voltage of the pixel signal read line 21 to (Vcut−Vthcut) when the voltage thereof is determined to be lower than (Vref−Vthjdg) by the column comparison unit 3. Here, Vcut and Vref are set so that Vref<Vcut is satisfied.

Next, the column amplifying unit 5 is described.

The column amplifying unit 5 has a column amplifier input capacitor 51, a first column amplifier return capacitor 52, a second column amplifier return capacitor 53, a column amplifier reset transistor 54, a column amplifier 55 and a column amplifier amplification factor change switch 57.

The column amplifier input capacitor 51 is connected to the pixel signal read line 21 at one end, and to the input terminal of the column amplifier 55 at the other end so that a potential change of the pixel signal read line 21 is sent to the column amplifier 55. The first column amplifier return capacitor 52 is connected to the input terminal of the column amplifier 55 at one end, and to the output terminal of the column amplifier 55 at the other end.

The second column amplifier return capacitor 53 for switching the amplification factor of the column amplifier part 5 is connected to the input terminal of the column amplifier 55 at one end via the column amplifier amplification factor change switch 57, and to the output terminal of the column amplifier 55 at the other end. The gate terminal of the column amplifier amplification factor change switch 57 is connected to a column amplifier amplification factor switching signal line 58, and the column amplifier amplification factor change switch 57 is turned on or off according to an column amplifier amplification factor switching signal. Therefore, the amplification factor of the column amplifying unit 5 can be changed according to the column amplifier amplification factor switching signal.

The column amplifier reset transistor 54 is connected to the input terminal of the column amplifier 55 at one end, and to the output terminal of the column amplifier 55 at the other end, and also is connected at its gate terminal to the column amplifier reset transistor 54 so that the column amplifier reset transistor 54 is turned on or off according to a column amplifier reset signal. Turning on the column amplifier reset transistor 54 resets the voltages held by the first column amplifier return capacitor 52 and the second column amplifier return capacitor 53.

In this manner, the column amplifying unit 5 amplifies the pixel signal with the amplification factor according to the column amplifier amplification factor switching signal, and outputs the amplified signal to the column noise canceling circuit 6.

The column noise canceling circuit 6 cancels the variation of the offsets of the pixel signals amplified by the column amplifying unit 5 and holds the voltage with canceled variation. Specifically, the column noise canceling circuit 6 has a clamp capacitor 60 whose one end is connected to the output line of the column amplifier 55, a sample hold (SH) capacitor 61 inserted between the other end of the clamp capacitor 60 and the ground potential, a clamp switch 62 whose one end is connected to a clamp 63 which is a wiring connection between the clamp capacitor 60 and an SH capacitor 61, while the other end of the clamp switch 62 is connected to a clamp potential line 64, and the gate terminal of the clamp switch 62 is connected to a clamp switch signal line 65 so that the clamp switch 62 is controlled by a clamp switch signal. Also, the capacity of the clamp capacitor 60 is Ccl, and the capacity of the sample hold capacitor 61 is Csh.

Thereby, the column noise canceling circuit 6 cancels the variation of the offsets of the pixel signals amplified by the column amplifying unit 5 with the clamp capacitor 60 and holds the voltage with canceled variation at the sample hold capacitor 61. The voltage held by the sample hold capacitor 61 allows the clamp 63 to serve as the connection wiring between the clamp capacitor 60 and the sample hold capacitor 61.

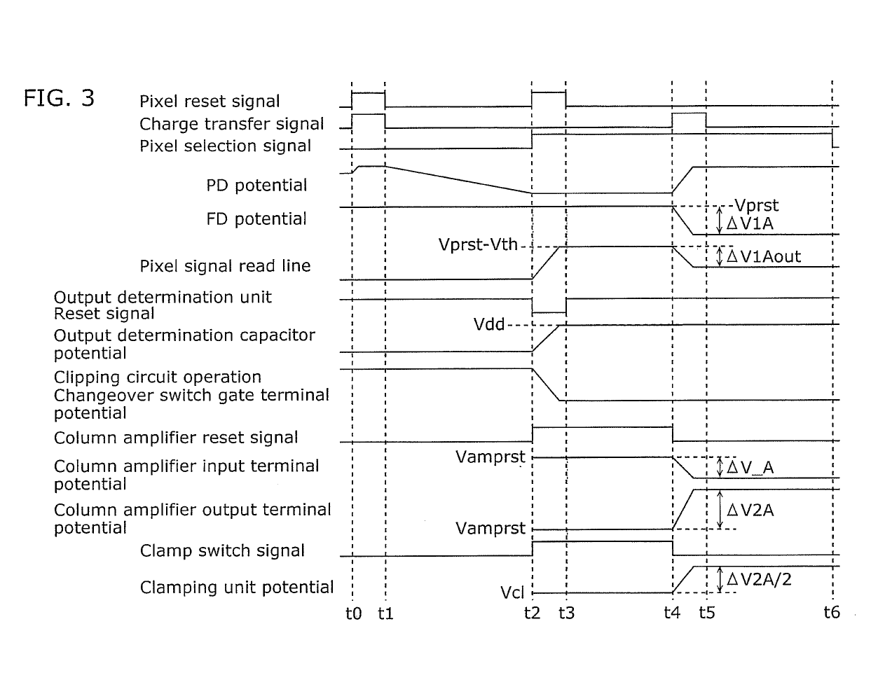

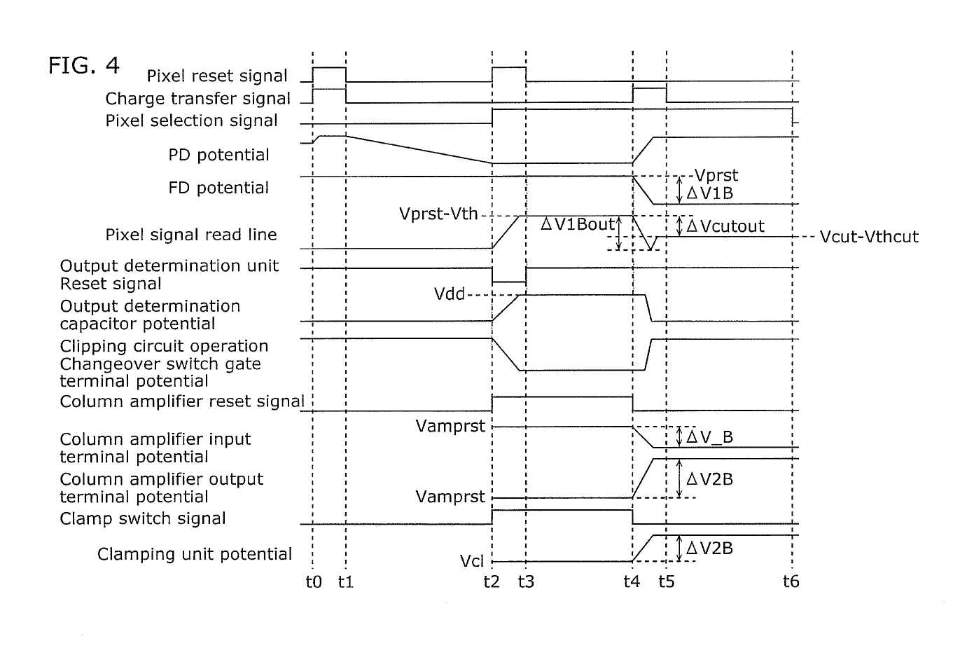

Next, the read operation of a pixel signal is described with reference to the timing charts shown in FIGS. 3 and 4. FIG. 3 shows the case where the amount of received light is small, thus the phenomenon PH2 has occurred, and FIG. 4 shows the case where the amount of received light is large, thus the phenomenon PH1 has occurred.

First, FIG. 3 is described. FIG. 3 shows a timing chart between the pixel reset signal, the electric charge transfer signal, the pixel selection signal, the output determination unit reset signal, the column amplifier reset signal, and the clamp switch signal. FIG. 3 further shows the potentials of PD 10, FD 12, the pixel signal read line 21, the output determination capacitor 31, the gate terminal of the clipping circuit operation change-over switch 42, the input terminal of the column amplifier 55, the output terminal of the column amplifier 55, and the clamp 63.

At a timing t0, the pixel reset signal is set to H level, and the potential of FD 12 is reset to Vprst (=VDD−Vth). Simultaneously, the electric charge transfer signal is set to H level, and the electric charge remaining in PD 10 is transferred to FD 12 so that the accumulated electric charge in PD 10 becomes substantially 0.

Next, at a timing t1, the potentials of the pixel reset signal and the electric charge transfer signal are set back to L level. Thereby, generated photoelectric charge in PD 10 starts to accumulate.

Next, at a timing t2, the pixel reset signal is set to H level so that the electric potential of FD 12 is reset to Vprst (=VDD−Vth) again. Simultaneously, by forming the source follower amplifier including the read transistor 14 and the current source 16 with the pixel selection signal being set to H level, the potential of (Vprst−Vth) is outputted to the pixel signal read line 21 (strictly describing (Vprst−Vth−α) is outputted thereto, however, for the sake of simplicity of description, α is omitted). Also, the column amplifier reset signal is set to H level so that the potentials of the input terminal of the column amplifier 55, and the output terminal of column amplifier 55 are set to the reset potential Vamprst of the column amplifier 55. Further, the clamp switch signal is set to H level so that the potential of the clamp 63 is set to a clamp potential (Vcl). Furthermore, the output determination unit reset signal is set to L level, and the voltage to be maintained by the output determination capacitor 31 is set to Vdd (H level) so that the column comparison unit 3 is reset. Here, the clamp potential Vcl is the voltage applied to the clamp potential line 64.

Next, at a timing t3, the pixel reset signal is set to L level. Also, the output determination unit reset signal is set to H level so as to switch to set the column comparison unit 3 in the enabled operation state.

Next, at a timing t4, the column amplifier reset signal is set to L level so that the column amplifying unit 5 is set in the amplification operation state. Simultaneously, the clamp switch signal is set to L level so that the clamp 63 is set in a floating state. Further, the charge transfer signal is set to H level so that the electric charge accumulated in the PD 10 is transferred to the FD 12. Consequently, the potential of the FD 12 becomes (Vprst−ΔV1A), and the potential of the pixel signal read line 21 is reduced to (Vprst−Vth−ΔV1Aout). The value of ΔV1Aout is proportional to the electric charge accumulated in the PD 10.

Here, as shown in FIG. 3 when the amount of received light is small and the phenomenon PH2 has occurred, the potential of the pixel signal read line 21 is higher than or equal to (Vref−Vthjdg), thus the potential held by the output determination capacitor 31 remains to be H level. Therefore, the voltage outputted from the column comparison unit 3, i.e., the potential of the gate terminal of the clipping circuit operation change-over switch 42 becomes L level. Thereby, the column output limiting unit 4 is separated from the pixel source follower.

Because of the affect of the reduction of the potential of the pixel signal read line 21 by ΔV1Aout, the potential of the input terminal of the column amplifier 55 is reduced by ΔV_A, and the output potential of the column amplifier 55 is increased by ΔV2A. The ratio between the input potential to the column amplifier 5 and the output potential therefrom, i.e., ΔV2A/ΔV1Aout corresponds to the gain of column amplifier 5. Because of the increase of the output potential of the column amplifier 5, the potential of the clamp 63 also increases from Vcl to (Vcl+ΔV2A/2) via the clamp capacitor 60. Here, it is assumed that the capacities of Ccl and Csh are equal. By reading the potential of clamp 63 from the solid-state imaging device 100, and detecting the difference between the read potential and the output Vcl in a dark light, the pixel signal can be read.

As described above, in the solid-state imaging device 100 according to the present embodiment, the On and Off states of the clipping circuit operation change-over switch 42 are switched according to a comparison result made by the column comparison unit 3, thus the clip transistor 41 is prevented from operating in the weak inversion region when the amount of received light is small, and occurrence of vertical stripes due to a column-wise characteristics difference in the clip transistors 41 can be prevented.

Next, the case where the amount of received light of FIG. 4 is large is described.

First, the operation of the solid-state imaging device 100 is the same as in FIG. 3 up to the timing t4.

Next, at the timing t4, the column amplifier reset signal is set to L level so that the column amplifying unit 5 is set in the amplification operation state. Simultaneously, the clamp switch signal is set to L level so that the clamp 63 is set in a floating state. Further, the charge transfer signal is set to H level so that the electric charge accumulated in the PD 10 is transferred to the FD 12. Consequently, the potential of the FD 12 becomes (Vprst−ΔV1B), and the potential of the pixel signal read line 21 is once reduced to (Vprst−Vth−ΔV1Bout). The value of ΔV1Bout is proportional to the electric charge accumulated in the PD 10, thus is higher than ΔV1Aout when the amount of received light is small, shown in FIG. 3.

At this point, the potential of the pixel signal read line 21 is reduced lower than (Vref−Vthjdg). Accordingly, the output voltage determination transistor 30 is turned on, thus the voltage held by the output determination capacitor 31 changes from H level to L level. Also, along with a change in the voltage level held by the output determination capacitor 31, the gate potential of the clipping circuit operation change-over switch 42 changes from L level to H level, thus the column output limiting unit 4 operates. Specifically, because of the change of the gate potential of the clipping circuit operation change-over switch 42 from L level to H level, the clipping circuit operation change-over switch 42 is turned on, thus the pixel signal read line 21 and the clip transistor 41 are electrically connected.

Accordingly, the potential of the pixel signal read line 21 is controlled so as not to fall below (Vcut−Vthcut) where the gate voltage and the threshold voltage of the clip transistor 41 are Vcut and Vthcut, respectively. Here, reduction amount of the potential of pixel signal read line 21 is limited by the column output limiting unit 4, i.e., ΔVcutout indicated by (Vprst−Vth−(Vcut−Vthcut)) is the limited variation amount.

The operations of the column amplifying unit 5 and the column noise canceling circuit 6 due to the affect of the reduction of the potential of the pixel signal read line 21 by ΔVcutout are the same as the description for FIG. 3, thus by reading the potential of clamp 63 from the solid-state imaging device 100, and detecting the difference between the read potential and the output Vcl in a dark light, the pixel signal can be read.

As described above, when the amount of received light is large, the solid-state imaging device 100 according to the first embodiment of the present invention can limit the potential of the pixel signal by operating the column output limiting unit 4.

Accordingly, in the case where the current source 16 includes an MOS transistor, cease of the operation of the source-drain voltage of the MOS transistor in a saturation region, and change of the current amount of the MOS transistor are prevented, thus the set current of the MOS transistor is maintained at a constant level. Consequently, even in the case where only a portion of the pixels 80 receives high luminance incident light, but the rest of the portion receives no incident light, a black level shift can be suppressed.

Also, as described above, in the solid-state imaging device 100 of the present embodiment, the clipping circuit operation change-over switch 42 switches electrical connection/disconnection between the pixel signal read line 21 and the clip transistor 41 according to a comparison result made by the column comparison unit 3, thereby preventing the clip transistor 41 from operating in the weak inversion region until the potential of the pixel signal is limited. Consequently, occurrence of vertical stripes can be prevented.

That is to say, the solid-state imaging device 100 can have both vertical stripe prevention characteristics and output potential limiting characteristics.

In other words, the solid-state imaging device 100 according to the first embodiment of the present invention can limit the voltages of the pixel signals of those columns that have a large amount of received light by providing the column comparison unit 3 and operating the column output limiting unit 4 of the columns. Also, in those columns that have a small amount of received light, the clip transistor 41 is prevented from operating in the weak inversion region by turning off the clipping circuit operation change-over switch 42 according to a comparison result made by the column comparison unit 3. Thereby, occurrence of vertical stripes on an image can be prevented. That is to say, the clip transistor 41 can be operated in each pixel source follower where the phenomenon PH1 (incidence of high luminance light) has occurred, and the operation of the clip transistor 41 can be stopped in each pixel source follower where the phenomenon PH2 (incidence of low luminance light) has occurred, thus no black level shift occurs around a high luminance subject when captured, and an image having a high quality having no vertical stripes as a side effect of the operation of the clip transistor 41 can be obtained.

As long as the pixel in the present embodiment has a function of converting a light signal into an electric signal, the same effect as in the described configuration can be obtained with another configuration.

In the present embodiment, the voltage of the pixel signal with which the column comparison unit 3 starts to operate can be switched by switching the reference voltage for determination Vref from an external circuit.

Also, in the present embodiment, the limited variation amount of the voltage of the pixel signal can be switched by switching the clip reference voltage Vcut from an external circuit.

Also, in the present embodiment, the reference voltage for determination Vref, the clip reference voltage Vcut, and the amplification factor of the column amplifying unit 5 are independently controlled, however, may be controlled in a cooperative manner. Specifically, when electric signals to be dealt with are high such as in the case where a bright subject is captured, the amplification factor of the column amplifying unit 5 is set to be small, and the reference voltage for determination Vref and the clip reference voltage Vcut are set to be low so that the range of the pixel source follower circuit is increased. Conversely, when electric signals to be dealt with are low such as in the case where a dark subject is captured, the amplification factor of the column amplifying unit 5 is set to be large, and the reference voltage for determination Vref and the clip reference voltage Vcut are set to be high so that the operation range of the pixel source follower circuit is reduced to a required minimum.

In other words, when the gain is small, i.e., the amount of received light is large, the variation in the currents of the pixel source followers of the solid-state imaging device has a small affect on the image quality, thus the reference voltage and the clipping voltage are lowered. On the other hand, when the gain is large, i.e., the amount of received light is small, the variation in the currents of the pixel source followers has a huge affect on the image quality, thus the reference voltage and the clipping voltage are each set to a high level so that the variation in the currents of the pixel source followers are suppressed. Consequently, the image quality improves.

In the case where a circuit for linking the above-described control can be added, a minimum required voltage can be secured in the pixel source follower in a subsequent stage processing circuit by the linking control, thus the amount of a black level shift can be suppressed to a minimum.

### Second Embodiment

Hereinafter, a second embodiment of the present invention is described with reference to the drawings.

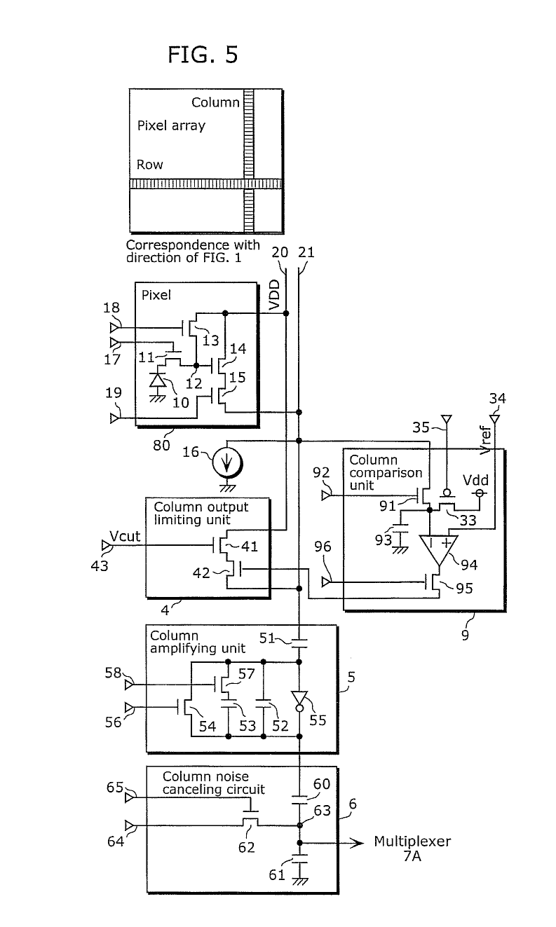

FIG. 5 is a circuit diagram showing the configuration of the solid-state imaging device according to the second embodiment of the present invention. The solid-state imaging device of the present embodiment differs from the first embodiment in that the solid-state imaging device includes the column comparison unit 9 instead of the column comparison unit 3. Except the difference, the solid-state imaging device of the present embodiment is the same as the solid-state imaging device 100 shown in FIG. 2, and the read operation of a pixel signal is the same as in the first embodiment. Hereinafter, points different from the first embodiment are mainly described.

As seen from FIG. 5, the column comparison unit 9 includes an output determination unit reset transistor 33, an output capture switch 91, an output hold capacitor 93, a comparator 94, and a determination output switch 95. The output determination unit reset transistor 33 is connected to the inverted input of the comparator 94 at one end, and to wiring to which the power supply voltage (Vdd) is applied at the other end, and the gate of the output determination unit reset transistor 33 is connected to the output determination unit reset signal line 35. The output capture switch 91 is connected to the pixel signal read line 21 at one end, and to the inverted input of the comparator 94 at the other end, and the gate of the output capture switch 91 is connected to an output capture signal line 92. The output hold capacitor 93 is connected to the inverted input of the comparator 94 at one end, and to the grand potential at the other end. The reference voltage for determination Vref is applied to a non-inverted input of the comparator 94. Also, the output of the comparator 94 is connected to one end of the determination output switch 95. The other end of the determination output switch 95 is connected to the gate terminal of the clipping circuit operation change-over switch 42, and the gate terminal of the determination output switch 95 is connected to a determination output switch signal line 96.

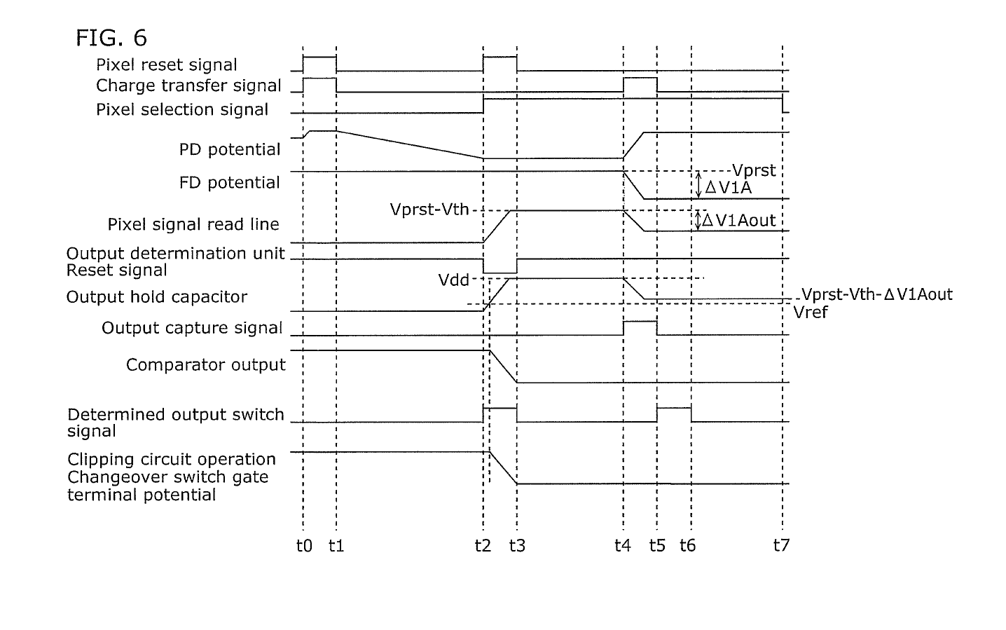

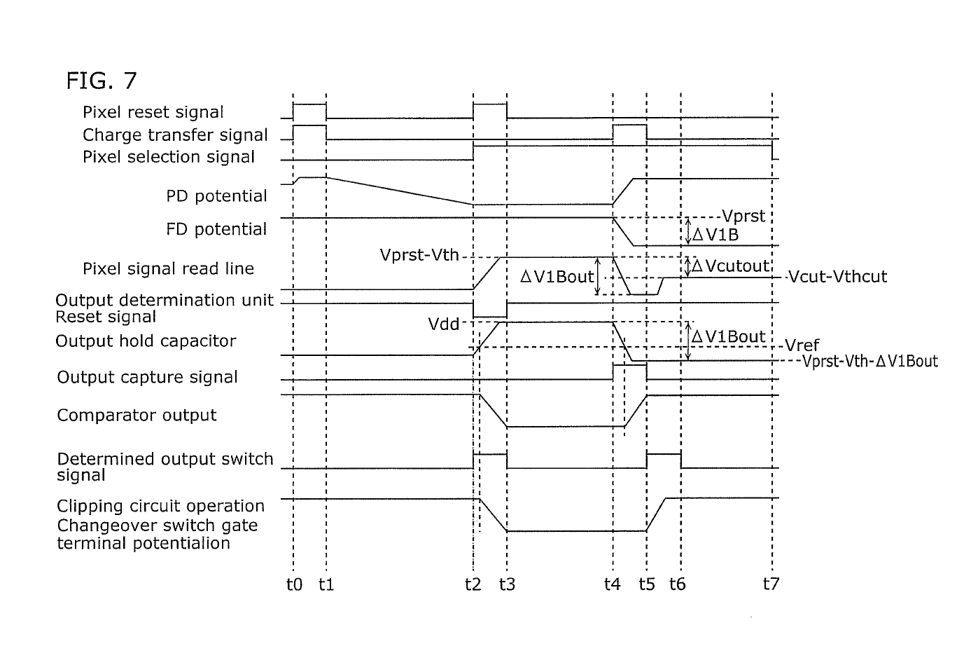

Next, the read operation of a pixel signal is described with reference to the timing charts shown in FIGS. 6 and 7. FIG. 6 shows the case where the amount of received light is small, thus the phenomenon PH2 has occurred, and FIG. 7 shows the case where the amount of received light is large, thus the phenomenon PH1 has occurred.

First, FIG. 6 is described. The operation of each unit other than column comparison unit 9 is the same as the operation described in FIG. 3. Compared with FIG. 2, FIG. 6 shows the signals related to the column comparison unit 9 instead of the signals related to the column comparison unit 3. Specifically, instead of the signals related to the column comparison unit 3, the voltage held by the output hold capacitor 93, an output capture signal applied to the output capture signal line 92, the voltage of the comparator output showing the output of the comparator 94, and a determination output switch signal applied to the determination output switch signal line 96. Also, compared with FIG. 2, FIG. 6 shows no signals related to the column amplifying unit 5, and the column noise canceling circuit 6.

First, at the timing t0 to t2, the output capture signal is set to L level, and a pixel signal is not captured. Also, in the meantime, the determination output switch signal is set to L level so that the output from the comparator 94 does not affect the column output limiting unit 4.

Next, at the timing t2, the output determination unit reset signal is set to L level so that the output hold capacitor 93 is reset to the power supply voltage (Vdd). Consequently, as the comparison result made by the comparator 94, L level is outputted.

Simultaneously, the determination output switch signal is set to H level so that the determination output switch 95 is turned on, and the gate terminal of the clipping circuit operation change-over switch 42 is reset to L level. Thereby, the clip transistor 41 and the pixel signal read line 21 are electrically disconnected, and the clip transistor 41 is separated from the pixel source follower. Also, because the clipping circuit operation change-over switch 42 is turned off, the clip transistor 41 is disabled.

Next, at the timing t3, the output determination unit reset signal is set to H level so that Vdd is held by the output hold capacitor 93. Also, the determination output switch signal is set to L level. The comparator 94 and the gate terminal of the clipping circuit operation change-over switch 42 are electrically disconnected. Here, the voltage immediately before the timing t3 is held by the gate capacitor of the clipping circuit operation change-over switch 42. Next, at the timing t4, the pixel transfer signal is set to H level so that the electric charge accumulated in the PD 10 is transferred to the FD 12. Consequently, the potential of the FD 12 becomes (Vprst−ΔV1A), and the potential of the pixel signal read line 21 is reduced to (Vprst−Vth−ΔV1Aout). The value of ΔV1Aout is proportional to the electric charge accumulated in the PD 10.

Simultaneously, the output capture signal is set to H level so that the voltage of the output hold capacitor 93 becomes the voltage of the pixel signal read line 21. That is to say, the voltage of the output hold capacitor 93 is set to (Vprst−Vth−ΔV1Aout). Here, as shown in FIG. 6 when the amount of received light is small and the phenomenon PH2 has occurred, the potential of the pixel signal read line 21 is higher than or equal to the reference voltage for determination Vref, thus the output of the comparator 94 remains to be L level.

Next, at a timing t5, the output capture signal is set to L level so that the potential of the pixel signal read line 21 is held by the output hold capacitor 93. Simultaneously, the determination output switch signal is set to H level so that the comparison result made by the comparator 94 is reflected to the gate electrode of the clipping circuit operation change-over switch 42. Thus, the clip transistor 41 remains to be disabled.

Next, at a timing t6, the determination output switch signal is set to L level so that the potential of the gate electrode of clipping circuit operation change-over switch 42 remains to be maintained at L level.

In this manner, when the amount of received light is small, the gate potential of the clipping circuit operation change-over switch 42 is set to L level so that the clip transistor 41 is separated from the pixel source follower. Thus, when the amount of received light is small, the clip transistor 41 is prevented from operating in the weak inversion region, and occurrence of vertical stripes due to a column-wise characteristics difference in the clip transistors 41 can be prevented.

Next, the case where the amount of received light of FIG. 7 is large is described. The signals and the wiring shown in FIG. 7 are the same as in FIG. 6.

First, the operation before the timing t4 is the same as the operation described in FIG. 6.

Next, at the timing t4, the pixel transfer signal is set to H level so that the electric charge accumulated in the PD 10 is transferred to the FD 12. Consequently, the potential of the FD 12 is reduced to (Vprst−ΔV1B). Here, the electric charge accumulated in the PD 10 when the amount of received light is large is greater than the electric charge accumulated in the PD 10 when the amount of received light is small, thus ΔV1B becomes higher than ΔV1A. Also, along with the potential reduction of the FD 12, the potential of the pixel signal read line 21 is also reduced so that the potential of pixel signal read line 21 becomes (Vprst−Vth−ΔV1Bout).

Simultaneously, the output capture signal is set to H level so that the voltage of the output hold capacitor 93 becomes the voltage of the pixel signal read line 21. That is to say, the voltage of the output hold capacitor 93 is set to (Vprst−Vth−ΔV1Bout). At this moment, the voltage of the output hold capacitor 93 becomes lower than Vref, and the output of the comparator 94 changes from L level to H level.

Next, at the timing t5, the output capture signal is set to L level so that the potential of the pixel signal read line 21 immediately before the timing t5 is held by the output hold capacitor 93. Next, the determination output switch signal is set to H level so that the comparison result made by the comparator 94 is reflected to the clipping circuit operation change-over switch 42.

Consequently, the gate potential of the clipping circuit operation change-over switch 42 is set to H level from L level, and the clipping circuit operation change-over switch 42 is turned on, thus the voltage of the pixel signal read line 21 is limited to (Vcut−Vthcut).

As a result, the gate potential of the clipping circuit operation change-over switch 42 is changed from L level to H level, and the clipping circuit operation change-over switch 42 is turned on to operate the clip transistor 41. Accordingly, the output potential of the pixel signal read line 21 is controlled so as not to fall below (Vcut−Vthcut) where the gate voltage and the threshold voltage of the clip transistor 41 are Vcut and Vthcut, respectively.

In this manner, when the amount of received light is large, the potential of the pixel signal can be limited to higher than or equal to a predetermined voltage by the operation of the clip transistor 41, thus even in the case where only a portion of the pixels receives high luminance incident light, but the rest of the portion receives no incident light, a black level shift can be suppressed.

Also, in the solid-state imaging device of the present embodiment, with the provided column comparison unit 9, the clip transistor 41 can be operated in only those columns that have a large amount of received light. Thus, the voltages of the pixel signals of those columns that have a large amount of received light can be limited and occurrence of vertical stripes on an image in those columns that have a small amount of received light can be prevented.

Also, compared with the solid-state imaging devices 100 and 200 of the first embodiment, the solid-state imaging device of the present embodiment includes the comparator 94 instead of the output voltage determination transistor 30 in order to compare the voltage of the pixel signal read line 21 with the reference voltage for determination Vref. Thereby, without being affected by the variation in the output voltage determination transistor 30 for each pixel signal read line 21, the voltage of the pixel signal read line 21 can be compared with the reference voltage for determination Vref even more precisely.

Furthermore, in the solid-state imaging device of the present embodiment, the output voltage of the pixel with which the clip transistor 41 starts to operate can be switched by switching the reference voltage for determination Vref.

In addition, in the solid-state imaging device of the present embodiment, the limited variation amount of the voltage of the pixel signal can be switched by switching the clip reference voltage Vcut.

Also in the present embodiment, similarly to the first embodiment, the reference voltage for determination Vref, the clip reference voltage Vcut, and the amplification factor of the column amplifying unit 5 may be controlled in a cooperative manner.

### Third Embodiment

Hereinafter, a third embodiment of the present invention is described with reference to the drawings.

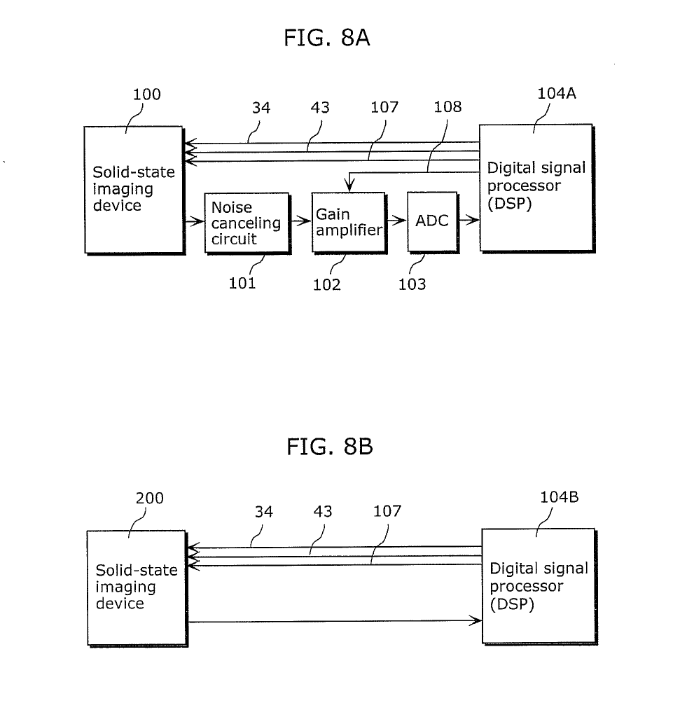

FIGS. 8A and 8B are device configuration diagrams showing an imaging apparatus (a camera, a camera module) according to the third embodiment of the present invention. Here, the imaging apparatus shown in FIG. 8A includes the solid-state imaging device 100 for outputting an analog signal shown in the first embodiment, and the imaging apparatus shown in FIG. 8B includes the solid-state imaging device 200 for outputting a digital signal shown in the second embodiment.

First, the case of FIG. 8A is described.

As seen from FIG. 8A, the pixel signal outputted from the solid-state imaging device 100 is inputted to a digital signal processor (DSP) 104A through a noise canceling circuit 101, a gain amplifier 102, and an ADC 103.

The DSP 104A processes the inputted pixel signal, while controlling the later-described adjustment of the range of the column amplifier output potential of the solid-state imaging device 100, gain setting for the column amplifier 5, and gain setting for the gain amplifier 102. That is to say, the DSP 104A serves as a controlling unit.

Also, the column comparison unit used for the solid-state imaging device 100 is the column comparison unit 3 shown in FIG. 2, or the column comparison unit 9 shown in FIG. 5. Also, the reference voltage for determination Vref, and the clip reference voltage Vcut are supplied by the DSP 104A. With the reference voltage for determination Vref and the clip reference voltage Vcut, the limited output variation amount of the pixel signal of the solid-state imaging device 100 can be controlled.

Furthermore, a column amplifier gain setting signal 107 is supplied to the column amplifier amplification factor switching signal line 58.

The DSP 104A controls the gain setting of the column amplifying unit 5, and the gain setting of the gain amplifier 102 based on the output from the ADC 103. Thereby, even after the digital conversion by the ADC 103, the S/N of the pixel signal is favorably maintained. For example, by optimizing the gains of the column amplifying unit 5 and the gain amplifier 102 for the subsequent digital conversion based on an output result of the preceding digital conversion, those gains for time-varying pixel signal can be always optimized and the S/N of the pixel signal after the digital conversion is favorably maintained.

Also, the DSP 104A controls the reference voltage for determination Vref and the clip reference voltage Vcut in conjunction with the column amplifier gain setting signal 107 of the column amplifying unit 5, and a gain setting signal 108 of the gain amplifier 102. Specifically, when the gain setting is small, the limited output variation amount is set to be small, while when the gain setting is large, the limited output variation amount is set to be large. When the gain setting is small, the variation in the currents of the pixel source followers has a small affect on the image quality, thus setting wide output potential range of the pixel source followers so as to have a large saturation amplitude is an effective approach. On the other hand, when gain setting is large, the output potential limiting function of the pixel source follower is useful for improving the image quality.

In other words, when the gain is small, i.e., the amount of received light is large, rather than reducing the variation in the currents of the pixel source followers of the solid-state imaging device 100, a wide operation range as the output potential range of the pixel source follower is secured and the reference voltage for determination Vref and the clip reference voltage Vcut are reduced, thus the limited variation amount is increased. On the other hand, when the gain is large, i.e., the amount of received light is small, decreasing the operation range of the pixel source follower in relation to the gains applied to the subsequent stage circuits, reduces the current variation in the pixel source followers, thus variation in black level can be suppressed. Accordingly, rather than securing a wide operation range, the variation in black level is reduced by priority so that the reference voltage for determination Vref and the clip reference voltage Vcut are increased. Consequently, the affect of noise can be suppressed at the time of low luminance of light, thus the image quality improves.

As described above, the present embodiment is useful for achieving a high image quality imaging apparatus.

The case of FIG. 8B is the same as in FIG. 8A except that the signals outputted from the solid-state imaging device are already digital signals, thus not required to be converted to digital signals.

The DSP 104B shown in FIG. 8B supplies the column amplifier gain setting signal 107 to the column amplifier amplification factor change switch 57 based on the signal outputted from the solid-state imaging device 200. Also, the reference voltage for determination Vref and the clip reference voltage Vcut are applied to the reference voltage for determination wiring 34 and the clip reference voltage wiring 43, respectively according to the column amplifier gain setting signal 107.

Thereby, even after the digital conversion by the column ADC 7B, the S/N of the pixel signal is favorably maintained. For example, by optimizing the gain of the column ADC 7B for the subsequent digital conversion based on an output result of the preceding digital conversion, the gain for time-varying pixel signal can be always optimized and the S/N of the pixel signal after the digital conversion is favorably maintained.

Furthermore, setting the reference voltage and the clipping voltage according to the gain of the column ADC 7B increases the quality of the image. Specifically, when the gain is small, i.e., the amount of received light is large, rather than reducing the variation in the currents of the pixel source followers of the solid-state imaging device 200, a wide operation range is secured by priority to set low Vref and Vcut. On the other hand, when the gain is large, i.e., the amount of received light is small, decreasing the operation range of the pixel source follower in relation to the gains applied to the subsequent stage circuits, reduces the current variation in the pixel source followers, thus variation in black level can be suppressed. Accordingly, rather than securing a wide operation range, the variation in black level is reduced by priority to increase Vref and Vcut so that the variation in the currents of the pixel source followers are suppressed. Consequently, the affect of noise can be suppressed at the time of low luminance of light, thus the image quality improves.

Also, in the present embodiment, the range of the output potential of the pixel source follower is controlled in conjunction with the gain setting, however, may be controlled according to the condition of other camera.

For example, the output potential range can be controlled such that when the monitor of a digital still camera is operated, a wide output potential range is set, while when an image to be recorded is captured, a narrow output potential range is set according to required range.

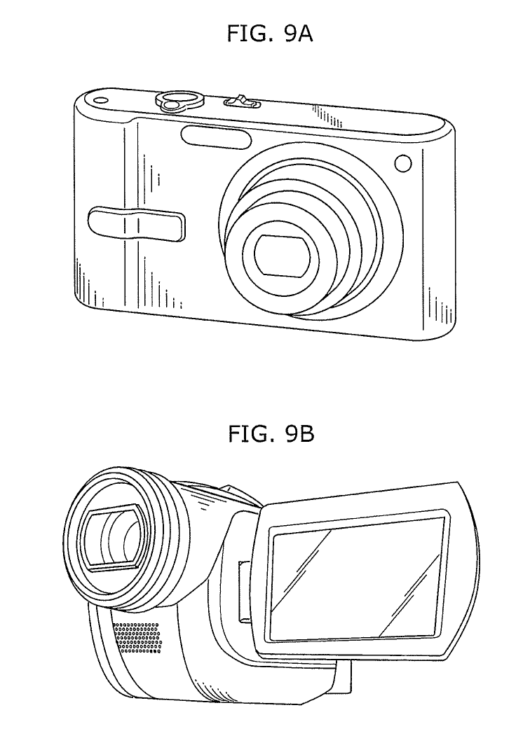

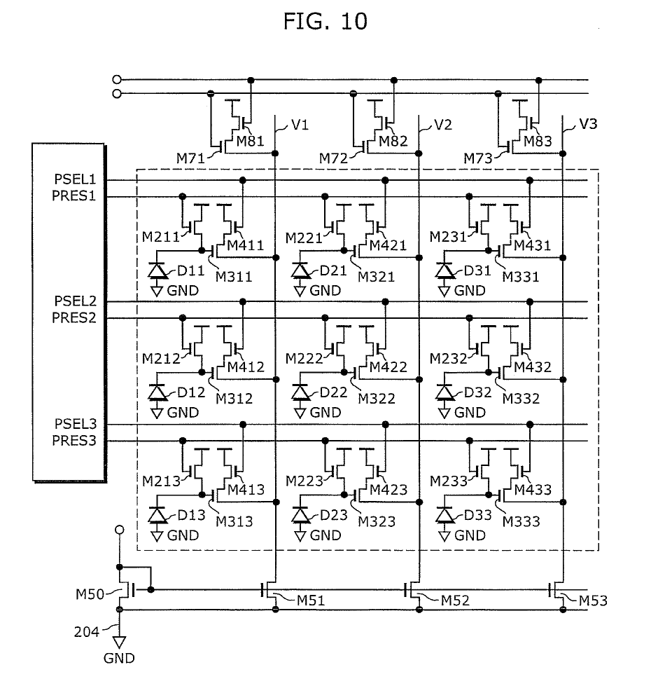

With such an imaging apparatus, occurrence of vertical stripes on the image as well as a black level shift can be prevented by the solid-state imaging devices 100 and 200 of the present invention, the imaging apparatus is achieved, for example, as the video camera shown in FIG. 9A, or a digital still camera shown in FIG. 9B. Some of the solid-state imaging device 100, the noise canceling circuit 101, the gain amplifier 102, the ADC 103, and the DSP 104A may be combined into a single chip as needed. Also, the solid-state imaging device 200 and the DSP 104B may be combined into a single chip.

So far, the present invention has been described based on the first to third embodiments, however, is not limited to these embodiments. As long as not departing from the spirit of the present invention, the embodiments obtained by making various changes, which occur to those skilled in the art, to the present embodiments, and other embodiments obtained by combining the components of different embodiments are also included in the scope of the present invention.

For example, in the above description, the output determination unit reset transistor 33 is a p-type transistor, but may be an n-type transistor and the polarity of the output determination unit reset signal may be reversed.

Also, in the above description, the clipping circuit operation change-over switch 42 is an n-type transistor, but may be a p-type transistor and may not include the determination inversion unit 32.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device according to the present invention achieves the following effect: no black level shift occurs around the subject even when a high luminance subject is captured, and no vertical stripes on the subject image occurs even when a low luminance subject is captured, and thus can be advantageously used as a digital still camera, a video camera, a surveillance camera, and the like, for which high image quality and product quality are demanded.

What is claimed is:

1. A solid-state imaging device having a plurality of pixels arranged in rows and columns, and a column signal line which is provided for each of the columns of the pixels and transmits a pixel signal from the pixels in the column, said solid-state imaging device comprising:
a comparison unit provided for each of the column signal lines and configured to compare a voltage of the pixel signal with a reference voltage, and to determine whether or not the voltage of the pixel signal is lower than the reference voltage;
a limiting unit provided for each of the column signal lines and configured to limit the voltage of the pixel signal to a clipping voltage; and
a switching unit provided for each of the column signal lines and configured to switch between enabled and disabled states of said limiting unit,
wherein said switching unit is configured to enable operation of said limiting unit when said comparison unit determines that the voltage of the pixel signal is lower than the reference voltage, and to disable operation of said limiting unit when said comparison unit determines that the voltage of the pixel signal is higher than or equal to the reference voltage.

2. The solid-state imaging device according to claim 1,
wherein said switching unit includes a transistor inserted in a wiring which connects between said limiting unit and the column signal line, and
said transistor is connected at its gate to an output line of said comparison unit and is configured to enable an electrical connection between said limiting unit and the column signal line when said comparison unit determines that the voltage of the pixel signal is lower than the reference voltage, and to disable an electrical connection between said limiting unit and the column signal line when said comparison unit determines that the voltage of the pixel signal is higher than or equal to the reference voltage.

3. The solid-state imaging device according to claim 1, further comprising
a control unit configured to notify said comparison unit of the reference voltage, and to notify said limiting unit of the clipping voltage.

4. The solid-state imaging device according to claim 3, further comprising
a variable gain amplifying unit which is provided for each of the column signal lines and is configured to amplify the pixel signal,
wherein said control unit further notifies said amplifying unit of a gain thereof so that said amplifying unit amplifies the pixel signal with the gain notified from said control unit.

5. The solid-state imaging device according to claim 4, further comprising
an A/D converter which is provided for each of the column signal lines and is configured to digitally convert the pixel signal amplified by said amplifying unit so as to output a digital value,
wherein said control unit further determines the gain of said amplifying unit so that the amplitude of the pixel signal amplified by said amplifying unit is suited to an optimized input range of said A/D converter, and determines the reference voltage and the clipping voltage according to the gain of said amplifying unit, and then notifies said comparison unit of the reference voltage and notifies said limiting unit of the clipping voltage.

6. The solid-state imaging device according to claim 4,
wherein said control unit further determines a gain of said amplifying unit so that the amplitude of the pixel signal amplified by said amplifying unit is suited to an optimized input range of an A/D converter disposed externally of said solid-state imaging device, and determines the reference voltage and the clipping voltage according to the gain of said amplifying unit, and then notifies said comparison unit of the reference voltage and notifies said limiting unit of the clipping voltage.

7. An imaging apparatus comprising said solid-state imaging device according to claim 1.
